(19) United States
(12) Patent Application Publication
(10) Pub. No.: US 2024/0244347 A1
(43) Pub. Date: Jul. 18, 2024

(54) IMAGING PIXEL TO MITIGATE CROSS-TALK EFFECTS

(71) Applicant: ams Sensors Belgium BVBA, Berchem (BE)

(72) Inventors: Jason INMAN, Rochester, NY (US); Kevin FRONCZAK, Fairport, NY (US)

(21) Appl. No.: 18/563,888

(22) PCT Filed: May 31, 2022
(86) PCT No.: PCT/EP2022/064755

§ 371 Date: Nov. 23, 2023

Related U.S. Application Data
(63) Continuation of application No. 17/352,776, filed on Jun. 21, 2021, now abandoned.

(51) Int. Cl. H04N 25/625; H04N 25/75

(52) U.S. Cl. CPC H04N 25/625; H04N 25/75

(57) ABSTRACT

An imaging pixel to mitigate cross-talk effects comprises a voltage supply node to receive a supply voltage, and an output node to provide a pixel output signal. The imaging pixel further comprises a photosensitive element, and a source follower transistor having a control node coupled to the photosensitive element. The source follower transistor is interposed between the voltage supply node and the output node. The imaging pixel comprises a clamping circuit being interposed between the voltage supply node and the output node.

### RELATED APPLICATIONS

The present application is a U.S. National Stage Application, filed under 35 U.S.C. § 371, of International Application No. PCT/EP2022/064755, filed on 31 May 2022, and claims priority from U.S. patent application Ser. No. 17/352,776, filed on 21 Jun. 2021, the contents of which is hereby incorporated by reference in their entirety.

### TECHNICAL FIELD

The disclosure relates to an imaging pixel to mitigate cross-talk effects in a row of a pixel array. The disclosure further relates to an image sensor with a plurality of image pixels to mitigate cross-talk effects in a row of a pixel array, and an electronic device comprising an image sensor.

### BACKGROUND

Image sensors are used in a plurality of electronic devices such as cameras, tablet computers or smartphones having a functionality for capturing images. An image sensor usually includes an array of imaging pixels arranged in pixel rows and pixel columns.

FIG. 1 shows an embodiment of a imaging sensor 1 comprising a plurality of imaging pixels 2 which are arranged in rows and columns of a pixel array 40. Each imaging pixel 2 includes a photosensitive element, for example a photodiode, for generating a charge in response to incident light. In principle, incoming light is collected by the photosensitive element of an imaging pixel, and the photosensitive element converts the light to electric charge.

Each imaging pixel 2 is connected to a respective column line 41 and a respective row line 42. The imaging sensor 1 comprises a control circuitry 50 that is coupled to a row control circuitry 60 and a column control circuitry/image readout circuitry 70. Row control circuitry 60 may receive row addresses from control circuitry 50 and supply corresponding row control signals RS, such as a row-select control signal, to the imaging pixels 2 over row lines 42. Column lines 41 are used for reading out pixel output signals from the imaging pixels 2 and for supplying bias signals, for example bias currents or bias voltages, to imaging pixels 2.

In particular, during a pixel readout operation a row in pixel array 40 may be selected using row control signal RS generated from row control circuitry 60, and a pixel output signal generated by an imaging pixel 2 located in said pixel row of the pixel array 40 can be read out along column line 41 to which the respective imaging pixel 2 is connected. Image readout circuitry 70 receives the pixel output signals over column lines 41. Image readout circuitry 70 may be configured to convert the received analog pixel output signals into corresponding digital pixel values.

FIG. 2 shows a configuration of a pixel array 40 with a plurality of imaging pixels 2 being arranged in rows and columns in the pixel array. For clarity, FIG. 2 shows only one imaging pixel 2 being connected to a column line 41.

The imaging pixel 2 comprises a photosensitive element 10 being configured to provide a photosensitive signal VPIX having a level that is dependent on the brightness of light incident on a photosensitive area of photosensitive element 10. The imaging pixel 2 comprises a source follower transistor 31 having a control node to apply the photosensitive signal VPIX that is used as gate control signal of source follower transistor 31. The photosensitive element 10 is coupled to the control node of source follower transistor 31. The imaging pixel 2 further comprises selection transistor 32 to select the imaging pixel for reading out a pixel output signal to column bus 41. Source follower transistor 31 and selection transistor 32 are arranged in a series connection between column line 41 and a supply potential VDD.

The imaging sensor 2 commonly comprises bias circuitries for supplying the bias signals, for example bias currents or bias voltages, to each of the column lines 41. FIG. 2 shows a bias circuitry 80 being coupled to column line 41 to supply bias signals to column line 41. Each of the column lines 41 is connected to a respective bias circuitry 80. According to common practice, bias circuitries 80 are located on an edge of pixel array 40.

According to a possible implementation, bias circuitry 80 may comprise a series connection of a source follower transistor 81 controlled by control signal Vbias and transistor 82 to activate/enable bias circuitry 80 that is controlled by a bias enabling signal BIAS_EN. The series connection of source follower transistor 81 and activation transistor 82 is coupled to a reference potential VSS and to column line 41 to supply the bias signal to column line 41.

According to the configuration of the image sensor 1 shown in FIG. 2, each of the column lines 41 is coupled to a clamping circuit (white level clamp) 20 that is configured to set a minimum voltage on the respective column line/bus 41 to which clamping circuit 20 is connected. In particular, clamping circuit 20 is configured to prevent an output voltage generated by an imaging pixel on column line 41 from going too low or dropping to ground to avoid bias circuitry 80 from being shut down.

The clamping circuit 20 may comprise source follower transistor 21 and a selection transistor 22 which are coupled in series between a supply line to provide supply potential VDD and column line 41. As shown in FIG. 2, source follower transistor 21 is controlled by control signal VC and selection transistor 22 is controlled by selection/enabling signal CLAMP_EN.

Common practice is to have clamping circuit 20 on the edge of pixel array 40, or on a logic chip near column bias circuitry 80. As a result of clamping circuit 20, the current driving column line/bus 41 will either pass through pixel 2/source follower transistor 31 or clamping circuit 20. In particular, there will be a signal-dependent voltage drop on supply line to supply supply voltage VDD in the pixel array. For large signals, i.e. low levels of photosensitive signal VPIX, current no longer flows through source follower transistor 31 of imaging pixel 2, but is diverted to clamping circuit 20 at the bottom of the pixel array 40. This could inversely effect readout on other pixels in the same row.

In conclusion, having clamping circuitries 20 in a location on the edge of a pixel array 40 or on a logic chip near column bias circuitry 80 can change the amount of current flowing through the pixel source follower transistors 31 as a function of the levels of photosensitive signals VPIX in the selected row. As a result, a victim pixel near the center of a row may have its pixel output signal level changed as a result of the levels of the pixel output signals of the other pixels in the same row (aggressor pixels).

FIG. 3 illustrates the effects of clamping circuits 20 located on the edge, for example at the top or bottom, of pixel array 40 on the change of supply voltage of the imaging pixels located in various rows. The upper diagrams of FIG. 3 show the effect on the voltage drop on the supply line of row R1 being the row that is furthest from clamping circuit 20, the effect on the voltage drop on the supply line of middle row R2 and the effect on the voltage drop on the supply line of row R3 being nearest to clamping circuits 20 in the case of small photosensitive signals VPIX. In this case the current is diverted to the respective source follower transistor 31 of the imaging pixel 2.

The lower three diagrams show the effects of clamping circuits 20 located at top or bottom of pixel array 40 on the voltage drop on the supply line of row R1 being furthest from clamping circuits 20, the voltage drop on the supply line of middle row R2 and the voltage drop on the supply line of row R3 being nearest to clamping circuits 20 in the case of large photosensitive signals VPIX. In the case of large photosensitive signals VPIX, bias current generated by bias circuitries 80 is diverted to clamping circuits 20.

As illustrated in FIG. 3, the pixel output signal of imaging pixels in rows further away from clamping circuits 20 will be impacted the most, and the pixel output signal of imaging pixels located in rows closest to the clamping circuits 20 will be less effected, because supply routes are already close, resulting in a small change of voltage drop gradient on the supply line.

There is a need to provide an imaging pixel to mitigate cross-talk effects through the supply voltage resulting from bias signals on a column line coupled to the imaging pixel. Moreover, there is a desire to provide an imaging sensor comprising a plurality of imaging pixels to mitigate cross-talk effects through the supply voltage resulting from bias signals on a column line of the imaging sensor. Furthermore, there is a desire to provide an electronic device with an improved imaging sensor having imaging pixels to mitigate cross-talk effects through the supply voltage.

### SUMMARY

An imaging pixel to mitigate cross-talk effects is specified in claim 1.

The image pixel comprises a voltage supply node to receive a supply voltage and an output node to provide a pixel output signal. The imaging pixel further comprises a photosensitive element and a source follower transistor having a control node coupled to the photosensitive element. The source follower transistor is interposed between the voltage supply node and the output node. The imaging pixel further comprises a clamping circuit being interposed between the voltage supply node and the output node.

According to the proposed configuration of the imaging pixel, the clamping circuitry is moved into the pixel so that there is a constant current flow through the pixel independent of the signal level of the photosensitive signal from the photosensitive element, leading to a constant voltage drop on the pixel array VDD supply. In particular, by having the clamping circuit in the pixel, the current on the power supply, and thus the voltage drop on the supply, will be constant and independent of the level of the photosensitive signal from the photosensitive elements of the aggressor pixels, i.e. referring to a row of pixels, the pixels on the left and right side of the center region of the row of pixels.

The imaging pixel may comprise a selection transistor to select the imaging pixel for reading out the pixel output signal. The selection transistor is interposed between the source follower transistor and the output node of the imaging pixel.

According to a possible embodiment of the imaging pixel, the clamping circuit is interposed between the voltage supply node and an internal node of the imaging pixel. The internal node is located between the source follower transistor and the selection transistor. The clamping circuit may be formed by a second source follower transistor being interposed between the voltage supply node and the internal node of the imaging pixel. According to this embodiment, the clamp source follower is placed in every pixel, in parallel with the existing pixel source follower.

According to another possible embodiment of the imaging pixel, the clamping circuit is arranged in parallel to a series connection of the source follower transistor and the selection transistor. In this configuration, the clamping circuit is formed by a second source follower transistor and a second selection transistor. That means that the series connection of the second source follower transistor and the second selection transistor of the clamping circuit is arranged in parallel to the series connection of the pixel source follower transistor and the pixel selection transistor.

According to a possible embodiment of the imaging pixel, the selection transistor and the second selection transistor may be arranged to be controlled by the same control signal. According to another embodiment of the imaging pixel, the source follower transistor and the second source follower transistor are configured to be matched to each other in order to mitigate mismatch effects.

An imaging sensor comprising a plurality of imaging pixels to mitigate cross-talk effects is specified in claim 9.

The imaging sensor comprises a pixel array including a plurality of the imaging pixels according to a configuration as explained above. The pixel array includes a plurality of column lines and row lines. The imaging pixels are arranged in rows and columns of the pixel array such that each row of the imaging pixels is connected to a respective row line to receive row control signals, and each column of the imaging pixels is connected to a respective column line for reading out the pixel output signals from the imaging pixels connected to the respective column line.

The imaging sensor comprises a plurality of bias circuitries. Each of the bias circuitries is connected to a respective column line for supplying bias signals to the imaging pixels connected to the respective column line.

According to an embodiment of the imaging sensor, each of the second source follower transistors of the imaging pixels comprises a clamp control node to receive a clamping control signal to control an operation state of the respective second source follower transistor.

According to a possible embodiment of the imaging sensor, the clamping control signals received by the respective clamp control nodes of the imaging pixels can be calibrated to deal with VT (Voltage/Temperature) process gradients. For this purpose, the imaging sensor may comprise a clamp control circuit that is configured to provide the respective clamping control signal for each row of imaging pixels. This configuration allows the clamping control signal to be calibrated on a per row basis, i.e. using the same level of the clamping control signal across a row of the pixel array and using different clamping control signals for imaging pixels in different rows.

According to another possible embodiment, the imaging sensor comprises a clamp control circuit that is configured to provide the respective clamping control signal for each column of imaging pixels. This configuration allows the respective clamping control signal for the imaging pixels to be calibrated on a per column basis, i.e. using the same level of the clamping control signal across a column of the pixel array and using different clamping control signals for imaging pixels in different columns.

According to another possible embodiment, the imaging sensor comprises a clamp control circuit being configured to provide a respective clamping control signal for each imaging pixel of the pixel array. This configuration allows the respective clamping control signal of each imaging pixel to be calibrated individually, i.e. on a per pixel basis.

An embodiment of an electronic device comprising an imaging sensor according to one of the embodiments, as explained above, is specified in claim 15.

According to a possible embodiment of the electronic device, the electronic device is embodied as a camera or a smartphone or a tablet computer or a video surveillance system or an automotive imaging system. The imaging sensor is embodied as a photosensitive component of the electronic device.

Additional features and advantages of the imaging pixel, the imaging sensor and the electronic device are set forth in the detailed description that follows. It is to be understood that both the foregoing general description and the following detailed description are merely exemplary, and are intended to provide an overview or framework for understanding the nature and character of the claims.

### BRIEF DESCRIPTION OF THE DRAWINGS

The accompanying drawings are included to provide further understanding, and are incorporated in, and constitute a part of, the specification. As such, the disclosure will be more fully understood from the following detailed description, taken in conjunction with the accompanying figures in which:

FIG. 1 shows an embodiment of an imaging sensor comprising imaging pixels arranged in rows and columns of a pixel array;

FIG. 2 shows an embodiment of an imaging sensor comprising a pixel array, bias circuitries and clamping circuits according to a conventional technology;

FIG. 3 illustrates a respective voltage drop on supply lines of various rows of a pixel array for small and large photosensitive signals of imaging pixels for an imaging sensor according to a conventional technology;

FIG. 4 shows an embodiment of an imaging sensor comprising a pixel array having imaging pixels with a respective in-pixel clamping circuit;

FIG. 5 illustrates an embodiment of an imaging pixel to mitigate cross-talk effects through the supply voltage;

FIG. 6 illustrates a respective voltage drop on supply lines of various rows of a pixel array for small and large photosensitive signals of imaging pixels for an imaging sensor having imaging pixels with in-pixel clamping circuits;

FIG. 7A shows a first embodiment of an imaging sensor with a clamping control signal of imaging pixels being calibrated on a per row basis;

FIG. 7B shows an embodiment of an imaging sensor with respective clamping control signals of the imaging pixels being calibrated on a per column basis;

FIG. 7C shows an embodiment of an imaging sensor with respective clamping control signals of imaging pixels being calibrated on a per pixel basis; and

FIG. 8 shows an embodiment of an electronic device comprising an imaging sensor with imaging pixels to mitigate cross-talk effects through the supply voltage.

### DETAILED DESCRIPTION

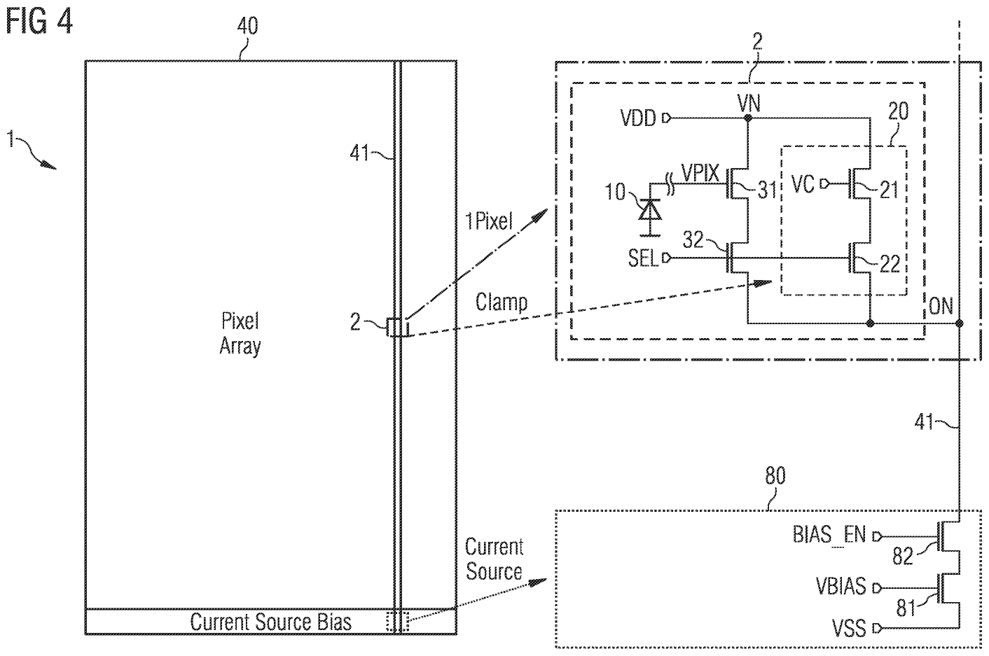

FIG. 4 shows an imaging sensor 1 comprising a plurality of imaging pixels 2 being arranged in rows and columns of a pixel array 40. The pixel array 40 includes a plurality of column lines/buses 41 and row lines 42. The imaging pixels 2 are arranged in rows and columns of the pixel array 40 such that each row of the imaging pixels 2 is connected to a respective row line 42 to receive row control signals, and each column of the imaging pixels 2 is connected to a respective column line 41 for reading out the pixel output signals from the imaging pixels connected to the respective column line 41.

The imaging sensor 1 comprises a plurality of bias circuitries 80. Each of the bias circuitries 80 is connected to a respective column line 41 for supplying bias signals to the imaging pixels 2 connected to the respective column line/bus 41.

According to a possible embodiment shown in FIG. 4, the bias circuitries 80 comprise a source follower transistor 81 being controlled by control signal VBIAS, and an activation transistor 82 being controlled by control signal BIAS_EN to activate the respective bias circuitry 80 supplying bias signals, for example bias currents or bias voltages, to the respective column line 41 to which bias circuitry 80 is connected. Each bias circuitry 80 is arranged between a respective column line/bus 41 and reference potential VSS. As shown in FIG. 4, the bias circuitries 80 are located on the edge, i.e. on the top or bottom side of pixel array 40.

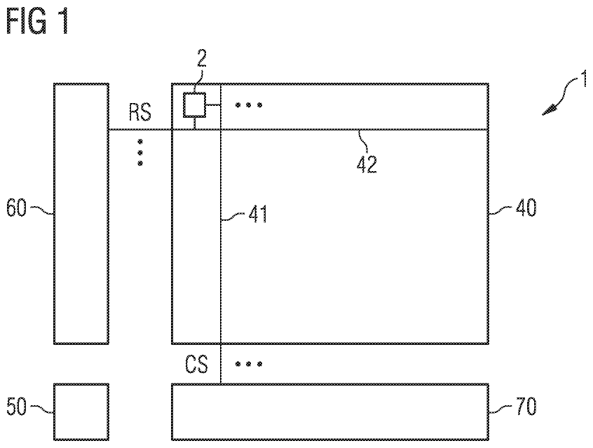

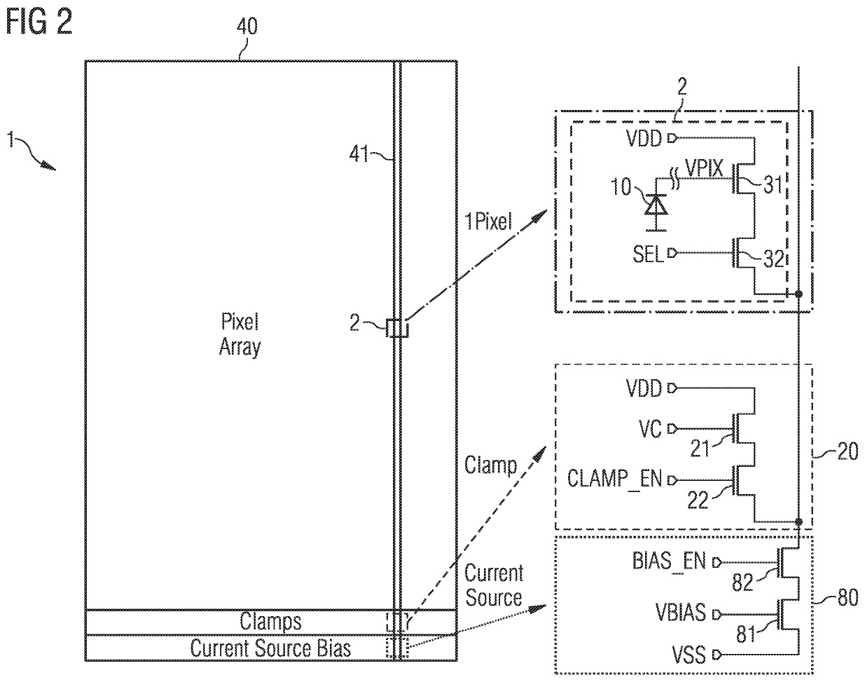

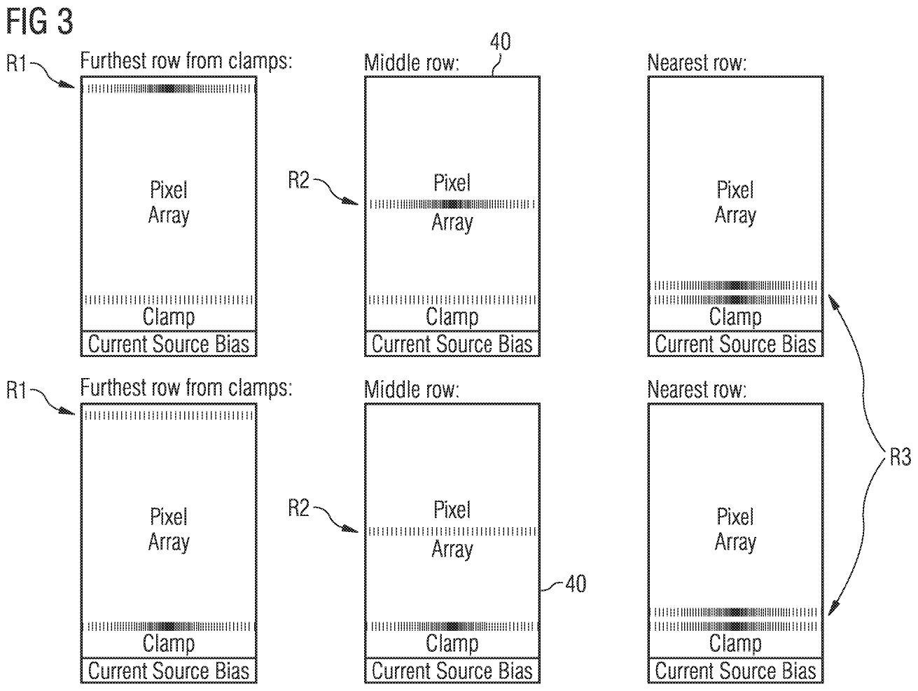

For reasons of simplified illustration, control circuitry 50, row control circuitry 60 and image readout/column control circuitry 70 shown in FIG. 1 have been omitted. Instead, the following will focus on the embodiment of the imaging pixels 2 included in the pixel array 40. One of the imaging pixels 2 is shown in FIG. 4 as an example for all other imaging pixels of the pixel array 40 in an enlarged view.

The imaging pixel 2 comprises a voltage supply node VN to receive a supply voltage VDD, and an output node ON to provide a pixel output signal. The imaging pixel 2 further comprises a photosensitive element 10 which may be configured as a photodiode. The photosensitive element 10 is embodied to provide a photosensitive signal VPIX. The level of the photosensitive signal VPIX is generated by the photosensitive element 10 in dependence on the brightness of light incident on photosensitive element 10.

The imaging pixel 2 further comprises a source follower transistor 31 having a control node coupled to the photosensitive element 10 to receive a photosensitive signal VPIX as control/gate signal. The source follower transistor 31 is interposed between the voltage supply node VN and the output node ON. The imaging pixel 2 further comprises a selection transistor 32 to select the imaging pixel 2 for reading out the pixel output signal of the imaging pixel. The selection transistor 32 is interposed between the source follower transistor 31 and the output node ON.

Referring to the embodiment of the imaging pixel 2 shown in FIG. 4, the source follower transistor 31 has a drain node coupled to the voltage supply node VN, a source node coupled to a drain node of selection transistor 32 and a control/gate node to receive photosensitive signal VPIX from photosensitive element 10. Selection transistor 32 has a control/gate node to receive a selection/row control signal SEL to select imaging pixel 2 for reading out the pixel output signal.

The imaging pixel 2 comprises a clamping circuit 20 to set the minimum voltage on the column line/bus 41. Referring to the embodiment of the imaging pixel 2 shown in FIG. 4, the clamping circuit 20 is arranged in parallel to a series connection of source follower transistor 31 and selection transistor 32.

The clamping circuit 20 is formed by a second source follower transistor 21 and a second selection transistor 22. Source follower transistor 21 has a drain node coupled to voltage supply node VN, a clamp control/gate node to receive a clamping control signal VC to control an operation state of the second source follower transistor 21, and a source node connected to a drain node of the second selection transistor 22. The second selection transistor 22 has a control/gate node to receive selection signal SEL to select/activate clamping circuit 20. A source node of second selection transistor 22 of clamping circuit 20 is coupled to the output node ON of imaging pixel 2.

According to a possible embodiment of the imaging pixel 2 shown in FIG. 4, selection transistor 32 and second selection transistor 22 of clamping circuit 20 are arranged to be controlled by the same control signal SEL.

According to a possible embodiment of the imaging pixel 2, source follower transistor 31 and second source follower transistor 21 of clamping circuit 20 are configured to be matched to each other. That means that pixel source follower 31 and clamp source follower 21 should have, for example, same size, close proximity, and common centroided, if possible, in order to mitigate mismatch effects.

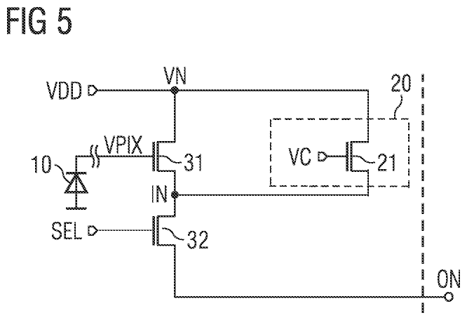

FIG. 5 shows another embodiment of the imaging pixel 2, wherein a second selection transistor 22 of clamping circuit 20 is omitted. According to the illustrated configuration of imaging pixel 2, clamping circuit 20 is only formed by second source follower transistor 21 being interposed between voltage supply node VN and an internal node IN of imaging pixel 2. Internal node IN is located between source follower transistor 31 and selection transistor 32.

In this configuration of the imaging pixel 2 shown in FIG. 5, clamping circuit 20 is interposed between voltage supply node VN and internal node IN. In particular, as illustrated in FIG. 5, drain node of second source follower transistor 21 is coupled to voltage supply node VN, and source node of a second source follower transistor 21 of clamping circuit 20 is coupled to internal node IN of imaging pixel 2.

Referring to the concept of the imaging pixel 2 shown in FIGS. 4 and 5, instead of placing clamping circuit 20 on an edge of pixel array 40, clamping circuit 20 is moved into the imaging pixel 2. That means that clamping circuit 20 is incorporated in each imaging pixel 2 of pixel array 40, and is thus embodied as an in-pixel clamping circuit.

By having a respective clamping circuit 20 in each imaging pixel 2, the current on the power supply, and thus the voltage drop on the supply, will be constant and independent of the level of the photosensitive signal VPIX of an aggressor pixel. Aggressor pixels are those pixels that are arranged within a row of pixels on either side of victim pixels located in a central area of the pixel row. By moving the clamping circuit 20 into each imaging pixel 2, there is a constant current flow through the pixel that is independent of a signal level of photosensitive signal VPIX, leading to a constant voltage drop on the pixel array VDD supply. In conclusion, the configuration of the in-pixel clamping circuit 20 allows aggressor-dependent signal change in victim pixels (cross-talk) to be reduced in a row of the pixel array.

Benefits could be more substantial for larger pixel area sizes, where there is a larger number of columns and thus a larger possible change in voltage drop based on signal levels (in the current technology). The proposed concept of in-pixel clamping circuits could alleviate such concerns.

A similar effect could be seen if larger bias currents were to be used for the source follower transistor. In this case a clamping circuit 20 arranged on the edge of a pixel array would be diverting more current away from the pixel array. In conclusion, the in-pixel clamping circuit is even more effective if the column load current is increased, resulting in increased voltage drop change in the pixel array, or if the supply resistance in the imaging pixel is increased, for example if the source follower transistor is powered on a supply that has thin traces, or, in the case of increased array size, specifically if there are more columns in a row of the pixel array.

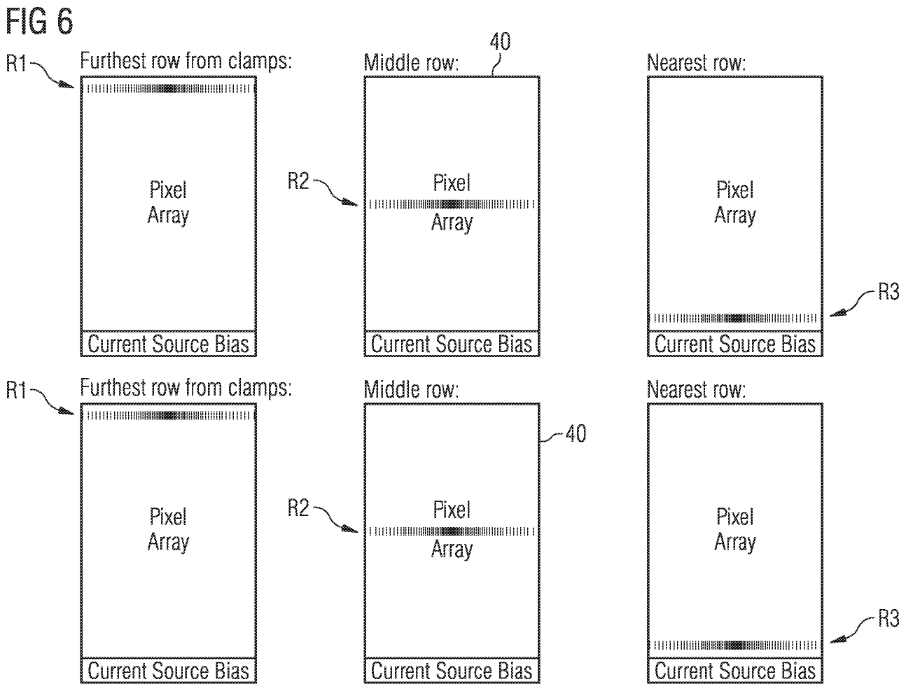

FIG. 6 illustrates the effect of achieving a constant voltage drop on supply lines to provide supply voltage VDD to each of the imaging pixels coupled to various row lines of the pixel array. The constant voltage drop on the various supply lines results from incorporating a respective clamping circuit 20 into each imaging pixel 2.

In particular, FIG. 6 shows, in the top three diagrams of pixel array 40, a voltage drop on supply lines to provide supply voltage VDD for imaging pixels arranged in row R1 being the row that is located furthest from bias circuitry 80, imaging pixels located in middle row R2 and imaging pixels located in row R3 being nearest to bias circuitry 80, if there are small levels of photosensitive signals in the imaging pixels. In this case bias signal/bias current provided by bias circuitry 80 is diverted to respective source follower transistor 31 of the imaging pixels. FIG. 6 shows, in the bottom three diagrams, the influence of large levels of photosensitive signals in imaging pixels on voltage drop on supply lines to provide supply voltage VDD for imaging pixels arranged in row R1, R2 and R3.

As illustrated in FIG. 6, voltage drop gradient on different supply lines in the pixel array does not change based on the level of photosensitive signal VPIX of imaging pixels arranged in a row or row position anymore, if clamping circuit 20 is embodied as an in-pixel clamping circuit of each imaging pixel of the pixel array.

The clamping control signal VC that is applied to a respective clamp control/gate node of second source follower transistor 21 of imaging pixels 2 can be driven on a per row or per column basis, or could be distributed in a 2D routing manner.

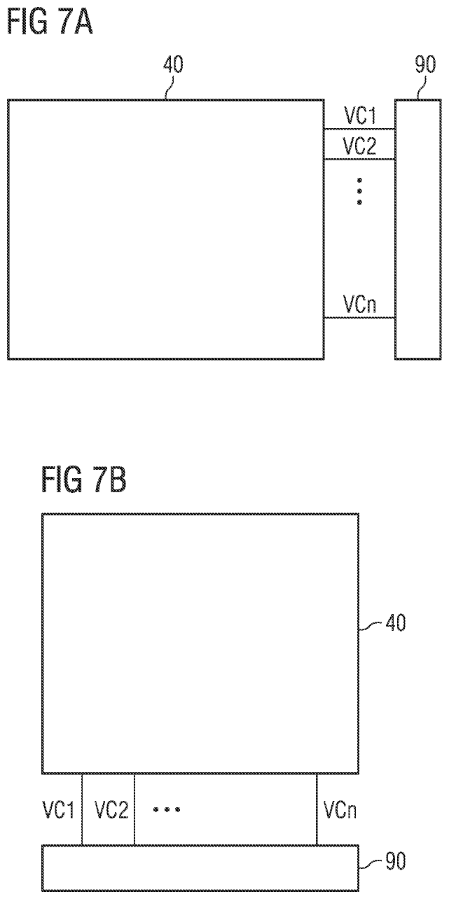

According to a possible embodiment, the imaging sensor 1 comprises a clamp control circuit 90 being configured to provide the respective clamping control signal VC1, . . . , VCn for each row 42 of pixel array 40, as illustrated in FIG. 7A. In this case the clamping control signals can be calibrated on a per row basis. According to a possible implementation, clamping control signal VC1 can be routed horizontally and different clamping control signals VC2, . . . , VCn can be applied for each horizontal route. In this case, clamp control circuit 90 may be realized as a DAC (Digital Analog Converter) with multiple taps driving multiple rows.

According to another possible embodiment to realize a calibration of the clamping control signals on a per row basis, the clamping control signals VC1, . . . , VCn could be routed both horizontally and vertically, and the global clamping control signal/clamping voltage could be changed when the next row is selected. This implementation may be realized by a fast settling DAC or buffer.

According to another possible embodiment, imaging sensor 1 may comprise a clamp control circuit 90 being configured to provide the respective clamping control signal VC1, . . . , VCn for each column 41 of imaging pixels 2, as illustrated in FIG. 7B. This configuration allows a calibration of the clamping control signals on a per column basis to be realized. In this case, the clamping control signal VC1 can be routed vertically, and different clamping control signals VC2, . . . , VCn can be applied for each vertical route. The calibration on a per column basis can be realized by a DAC with multiple taps driving multiple columns.

According to another possible embodiment of the imaging sensor 1, the clamping control signals can be calibrated on a per pixel basis. In this case, imaging sensor 1 comprises may a clamp control circuit 90 being configured to provide a respective clamping control signal VC1, . . . , VCn for each imaging pixel 2 of the pixel array 40 individually, as illustrated in FIG. 7C. In particular, clamp control circuit 90 may be configured to route clamping control signals VC1, . . . , VCn vertically with a respective different voltage level per vertical route. When a next row is selected, the new level of the clamping control signal may be selected from row control circuitry 60 which may be realized by a DAC to drive the selected row.

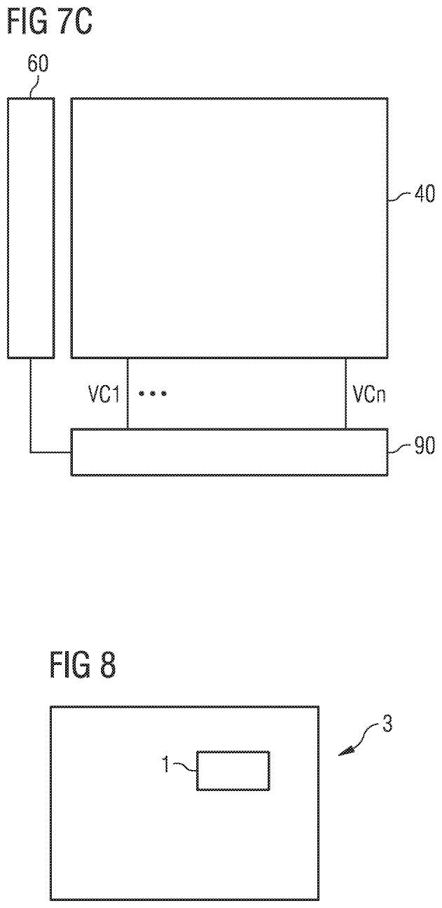

The proposed concept of an in-pixel clamping circuit could basically be used in any type of pixel utilizing a source follower transistor where a white clamp is also used on a per column basis. FIG. 8 shows an embodiment of an electronic device 3 comprising an imaging sensor 2. The electronic device 3 can be embodied, for example, as a camera or a smartphone or a tablet computer or a video surveillance system or an automotive imaging system. The imaging sensor 2 comprises a pixel array 40 with imaging pixels having an in-pixel clamping circuit 20 as shown in FIGS. 4 and 5. The imaging sensor 2 may be embodied as a photosensitive component of the electronic device.

The embodiments of the imaging pixel, the imaging sensor and the electronic device disclosed herein have been discussed for the purpose of familiarizing the reader with novel aspects of the design of the imaging pixel, the imaging sensor and the electronic device. Although certain embodiments have been shown and described, many changes, modifications, equivalents and substitutions of the disclosed concepts may be made by one having skill in the art without unnecessarily departing from the scope of the claims.

In particular, the design of the imaging pixel, the imaging sensor and the electronic device is not limited to the disclosed embodiments, and gives examples of many alternatives as possible for the features included in the embodiments discussed. However, it is intended that any modifications, equivalents and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

### REFERENCES

1 imaging sensor
2 imaging pixel
3 electronic device
10 photosensitive element
20 clamping circuit
21 second source follower transistor
22 second selection transistor
31 source follower transistor
32 selection transistor
40 pixel array
41 column line
42 row line
50 control circuitry
60 row control circuitry
70 column control circuitry
80 bias circuitry
90 clamping control circuit

1. An imaging pixel to mitigate cross-talk effects, comprising:
a voltage supply node to receive a supply voltage,
an output node to provide a pixel output signal,
a photosensitive element,
a source follower transistor having a control node coupled to the photosensitive element, the source follower transistor being interposed between the voltage supply node and the output node,
a clamping circuit being interposed between the voltage supply node and the output node,
a selection transistor to select the imaging pixel for reading out the pixel output signal, the selection transistor being interposed between the source follower transistor and the output node,
wherein the clamping circuit is interposed between the voltage supply node and an internal node of the imaging pixel, the internal node being located between the source follower transistor and the selection transistor,
wherein the clamping circuit is formed by a second source follower transistor being interposed between the voltage supply node and the internal node.

2-7. (canceled)

8. The imaging pixel of claim 1, wherein the source follower transistor and the second source follower transistor are configured to be matched to each other.

9. An imaging sensor, comprising:
a pixel array including a plurality of the imaging pixels as claimed in claim 1,
wherein the pixel array includes a plurality of column lines and row lines,
wherein the imaging pixels are arranged in rows and columns of the pixel array such that each row of the imaging pixels is connected to a respective row line to receive row control signals, and each column of the imaging pixels is connected to a respective column line for reading out the pixel output signals from the imaging pixels connected to the respective column line.

10. The imaging sensor of claim 9, comprising:
a plurality of bias circuitries,
wherein each of the bias circuitries is connected to a respective column line for supplying bias signals to the imaging pixels connected to the respective column line.

11. The imaging sensor of claim 9, wherein each of the second source follower transistors of the imaging pixels comprises a clamp control node to receive a clamping control signal to control an operation state of the respective second source follower transistor.

12. The imaging sensor of claim 11, comprising:
a clamp control circuit being configured to provide the respective clamping control signal for each row of the imaging pixels.

13. The imaging sensor of claim 11, comprising:
a clamp control circuit being configured to provide the respective clamping control signal for each column of the imaging pixels.

14. The imaging sensor of claim 11, comprising:
a clamp control circuit being configured to provide a respective clamping control signal for each imaging pixel of the pixel array.

15. An electronic device, comprising:
an imaging sensor as claimed in claim 9,
wherein the electronic device is embodied as a camera or a smartphone or a tablet computer or a video surveillance system or an automotive imaging system, and wherein the imaging sensor is embodied as a photosensitive component of the electronic device.
